(19) United States
(12) Patent Application Publication
(10) Pub. No.: US 2018/0292837 A1
(43) Pub. Date: Oct. 11, 2018

(54) MOBILE ROBOT HAVING AUTOMATIC CHARGING MODULE

(71) Applicants: LI-PAI CHEN, NEW TAIPEI CITY (TW); RICHARD CHI-HSUEH, SAN DIEGO, CA (US)

(72) Inventors: LI-PAI CHEN, NEW TAIPEI CITY (TW); RICHARD CHI-HSUEH, SAN DIEGO, CA (US)

(21) Appl. No.: 15/884,688

(22) Filed: Jan. 31, 2018

Related U.S. Application Data
(60) Provisional application No. 62/481,704, filed on Apr. 5, 2017.

(51) Int. Cl. G05D 1/02; H02J 7/00

(52) U.S. Cl. CPC G05D 1/0225; H02J 7/0042; Y10S 901/01; G05D 2201/0215; G05D 1/0236

(57) ABSTRACT

A mobile robot having an automatic charging module is disclosed. It comprises a robot main body having a mobile module, a charging module and a processing system electrically connected to the mobile module and the charging module; a laser system having a rotation module disposed on a top side of the robot main body and a plurality of laser modules electrically connected to the processing system; and a charging base having a positive electrode output end and a negative electrode output end respectively disposed on two seats thereof.

### CROSS REFERENCE TO RELATED APPLICATION

This application claims the benefits from U.S. Provisional Application No. 62/481,704, filed on Apr. 5, 2017, currently pending, the subject matter of which is incorporated herein by reference.

### BACKGROUND OF THE INVENTION

### Field of the Invention

The present invention relates to a mobile robot having an automatic charging module which comprises a mobile robot to actively find a location of a charging station by a four-axis laser.

### Description of Related Art

With the advancement of technology, many devices are developed toward unmanned operations. For instance, some major manufacturers strive to develop the technologies of unmanned aerial vehicles and unmanned vehicles. Furthermore, some manufacturing factories adopt fully automated equipment to assist with production operations, e.g. transportation, welding, assembling and the like. The fully automated equipment has high speed as well as high accuracy and can be carried out for 24 hours without interruption. As for general household appliances, there are also many automated products available on the market. For instance, a robotic vacuum cleaner is one of the most popular household appliances in these years. An owner can set a cleaning time of the robotic vacuum cleaner for automatically cleaning the floor whenever the owner is not at home. The robotic vacuum cleaner can reach many dead spaces to clean due to its small and flat body, or it can even show a path on a planar graph of owner's home simultaneously, allowing the owner to know which locations have been cleaned.

However, the fully automated equipment relies on electricity as a main energy source, so it must be connected to a power supply or recharged when it does not have sufficient electricity. For instance, the robotic vacuum cleaner is recharged mainly by the owner placing it back to a charging station or by itself returning to the charging station after it moves to clean for a period of time. If the robotic vacuum cleaner is designed for a self-drive type as the latter one, it must have a function of finding the charging station autonomously.

The Taiwan patent TWI597038 (B), issued on 1 Sep. 2017, disclosed a cleaning robot and a charging system. The charging system comprises a cleaning robot and a charging station having an infrared emitter to emit an infrared ray. The infrared ray includes a first boundary and a second boundary and carries a coding information. In such a case, a non-omnidirectional light detector detects the infrared ray to obtain a location of the charging station when the cleaning robot moves and touches the first boundary or the second boundary of the infrared ray so that the cleaning robot can move to the charging station along the first boundary for charging.

The method of using the charging station emitting a light to the mobile cleaning robot for reception and further getting the location of the charging station when it enters a light emitting area as described above belongs to a passive way to charge. In other words, the cleaning robot is unable to find the charging station actively. Moreover, the cleaning robot may fail to be charged instantly if it has run out of battery and does not pass through or not yet enter the light emitting area of the charging station.

### SUMMARY OF THE INVENTION

In view of the above-mentioned problems, the object of the present invention is to provide a mobile robot having an automatic charging module, especially to provide a mobile robot which can actively find a location of a charging station and correct its own movement route to accurately reach the charging station for charging instantly.

Disclosed herein is a mobile robot having an automatic charging module. It comprises a robot main body having a mobile module, a charging module and a processing system electrically connected to the mobile module and the charging module; a laser system having a rotation module disposed on a top side of the robot main body and a plurality of laser modules electrically connected to the processing system; and a charging base having a positive electrode output end and a negative electrode output end respectively disposed on two seats thereof. The plurality of laser modules are arranged at intervals of equal angles

According to an embodiment of the present invention, the charging module is provided with a positive electrode input end and a negative electrode input end.

According to an embodiment of the present invention, the positive electrode input end and the negative electrode input end are electrically connected to a storage battery.

According to an embodiment of the present invention, each of the plurality of laser modules straight emits a laser beam.

According to an embodiment of the present invention, the plurality of laser modules are arranged at intervals of 90 degree angles.

According to an embodiment of the present invention, the rotation module rotates 4-6 turns in one second.

According to an embodiment of the present invention, each of the two seats is provided with at least one spring.

### BRIEF DESCRIPTION OF THE DRAWINGS

FIG. 1 is a schematic diagram showing a mobile robot having an automatic charging module according to the present invention;

FIG. 2 is a block diagram showing a mobile robot having an automatic charging module according to the present invention;

FIG. 3 is a schematic diagram showing a mobile robot having an automatic charging module in movement according to the present invention.

### DETAILED DESCRIPTION OF THE PREFERRED EMBODIMENT

Hereinafter, an exemplary embodiment of the present invention will be described in detail with reference to the accompanying drawings.

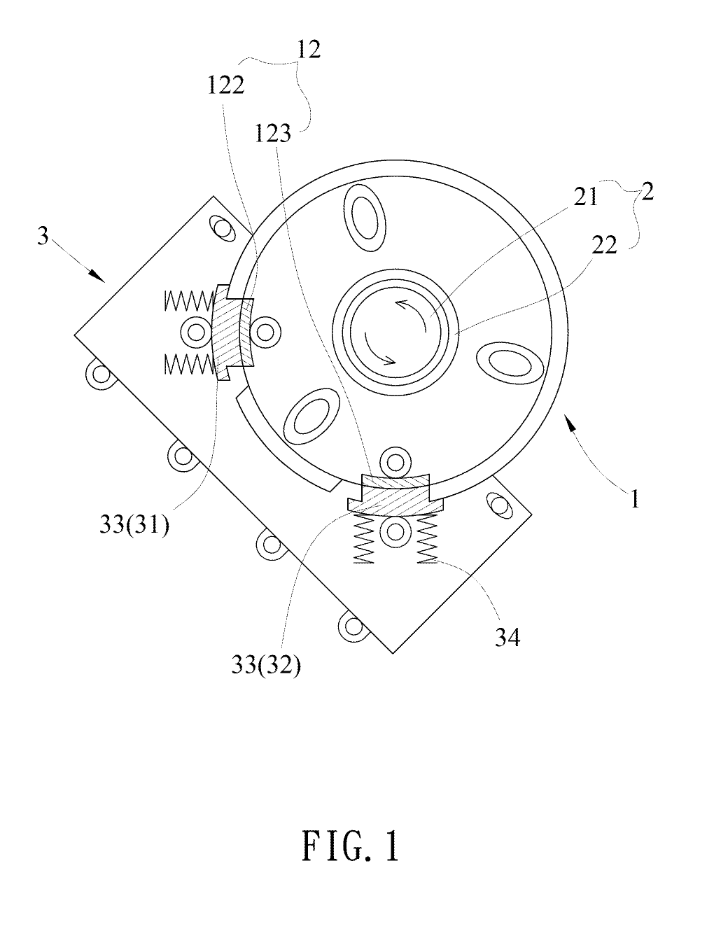

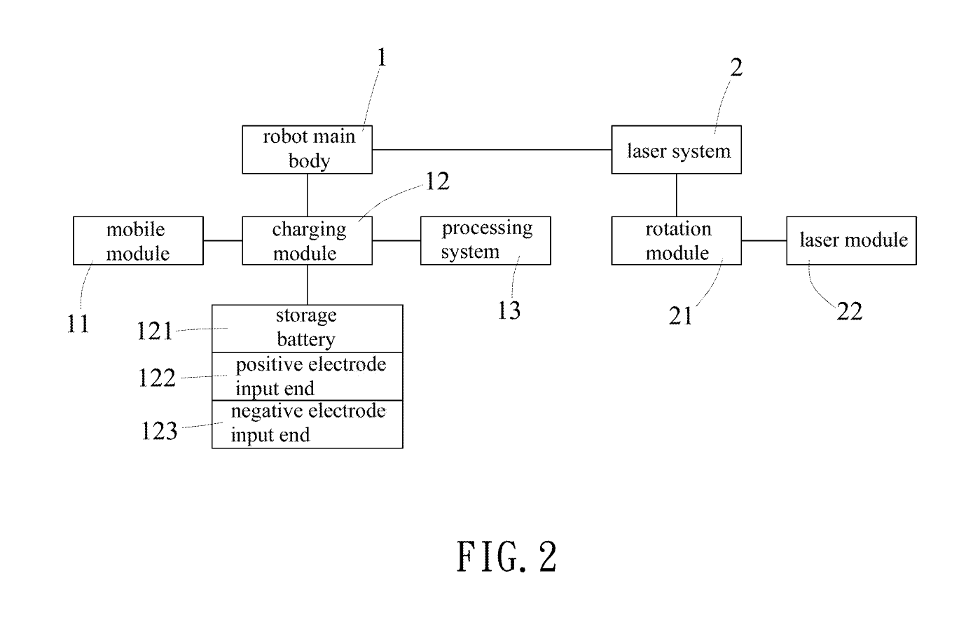

Referring to FIG. 1 and FIG. 2, a mobile robot having an automatic charging module according to the present invention comprises is disclosed. It comprises a robot main body (1), a laser system (2), and a charging base (3). The robot main body (1) has a mobile module (11), a charging module (12) and a processing system (13). The processing system (13) is electrically connected to the mobile module (11) and the charging module (12). The charging module (12) is connected to a storage battery (121) and further provided with a positive electrode input end (122) and a negative electrode input end (123). The storage battery (121) is charged by an input electric power from the positive electrode input end (122) and the negative electrode input end (123). The laser system (2) has a rotation module (21) disposed on a top side of the robot main body (1) and a plurality of laser modules (22) electrically connected to the processing system (13). The plurality of laser modules (22) are arranged at intervals of equal angles, preferably 90 degree angles, and each of the plurality of laser modules (22) straight emits a laser beam (221). The rotation module (21) rotates 4-6 turns in one second. The charging base (3) has a positive electrode output end (31) and a negative electrode output end (32) respectively disposed on two seats (33) thereof. Each of the two seats (33) is provided with at least one spring (34) so as to provide a buffer action when the robot main body (1) reaches the two seats (33).

Accordingly, the rotation module (21) can drive the laser beam (221) to rotate continuously. If the plurality of laser modules (22) are arranged at intervals of 90 degree angles, there are four laser modules (22) which can be designed for a four-axis laser. The laser beams (221) emitted from the plurality of laser modules (22) alternately radiate to the charging base (3) when the robot main body (1) moves, so the processing system (13) of the robot main body (1) can calculate a position of the charging base (3) and a distance from the robot main body (1) and further drive the mobile module (11) of the robot main body (1) to move toward the charging base (3).

As shown in FIG. 1 and FIG. 2, a schematic diagram and a block diagram showing a mobile robot having an automatic charging module according to the present invention are disclosed. The robot main body (1) can be a cleaning robot in one embodiment. The robot main body (1) has a cylindrical shape. A bottom side of the robot main body (1) is disposed with the mobile module (11) which may have a plurality of wheels so that the robot main body (1) can move straight forward and backward or turn. Additionally, the bottom side of the robot main body (1) is provided with a brush for cleaning the floor and a suction of a vacuum cleaner. The brush turns to sweep dust or trash on the floor and the dust or trash are sucked into a dust collection box by the suction when the robot main body (1) moves. The charging module (12) is disposed on a lateral margin of the robot main body (1). The positive electrode input end (122) and the negative electrode input end (123) are arranged apart by a distance and acted as a junction point for receiving the input electric power and further providing the input electric power for the storage battery (121). The processing system (13) is disposed in an interior of the robot main body (1) and electrically connected to the mobile module (11) and the charging module (12). Since the robot main body (1) is not human-controlled, a front side of the robot main body (1) is usually installed with a barrier sensor, e.g. an infrared transceiver device, for detecting whether there is an obstacle in front. If the robot main body (1) is quite close to the obstacle, the barrier sensor sends back a signal to the processing system (13), and then the processing system (13) gives instructions to the mobile module (11) for turning the plurality of wheels to change direction and avoid the obstacle.

The storage battery (121) of the charging module (12) requires an external power to recharge, so the robot main body (1) is further provided with the charging base (3) comprising the positive electrode output end (31) and the negative electrode output end (32). The positive electrode output end (31) and the negative electrode output end (32) are acted as a junction point of an output electricity power, and they are usually placed on the floor near sockets in the house to transmit supply mains from the sockets to the charging base (3). The supply mains is further supplied to the charging module (12) of the robot main body (1) by the positive electrode output end (31) and the negative electrode output end (32). In such a case, a height of the charging base (3) needs to be designed identical to a height of the charging module (12) of the robot main body (1). Furthermore, the positive electrode output end (31) and the negative electrode output end (32) are respectively disposed on the two seats (33) to prevent damage to the robot main body (1) when the robot main body (1) contacts the charging base (3) for charging. Each of the two seats (33) has one end provided with the at least one spring (34) so as to provide a buffer action and prevent damage to an appearance or the junction points when the robot main body (1) reaches the two seats (33).

For the robot main body (1) to actively find a location of the charging base (3), the top side of the robot main body (1) is disposed with the laser system (2) which comprises the plurality of laser modules (22) accommodated in the rotation module (21). In one embodiment, the plurality of laser modules (22) are arranged at intervals of 90 degree angles and surrounding a center point of the rotation module (21). Namely, there are four laser modules (22) in all to constitute a four-axis laser system (2), and the four laser modules (22) straight emit visible or invisible light.

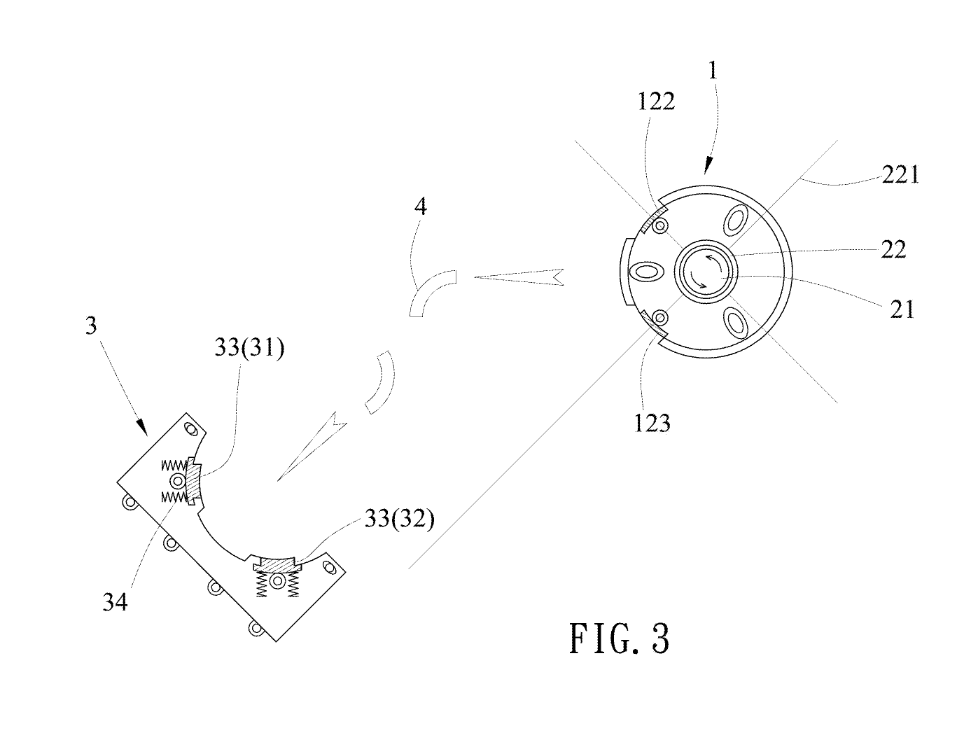

When electric quantity of the storage battery (121) is less than a predetermined value, the robot main body (1) starts to look for the charging base (3). Since the robot main body (1) usually starts from the charging base (3) to operation, the processing system (13) can record the path starting from the charging base (3) and control the mobile module (11) to return to the charging base (3) based on the previously recorded path. However, in an operation process, the robot main body (1) may only return to the vicinity of the charging base (3) instead of reaching the charging base (3) precisely due to a position of the obstacle in the path being changed. In such a case, as shown in FIG. 3, the rotation module (21) rotates 4-6 turns in one second and the four laser modules (22) of the laser system (2) emit the laser beams (221) to search a position of the charging base (3). When the laser system (2) detects the location of the charging base (3), the processing system (13) starts to correct a movement route of the mobile module (11) to accurately reach the charging base (3) for charging instantly.

The laser beams (221) rotating on the rotation module (21) constantly irradiate on the charging base (3). Specifically, the first laser beam (221) contacts the charging base (3) at 0 second; the second laser beam (221) contacts the charging base (3) at ¼ second; the third laser beam (221) contacts the charging base (3) at 2/4 second; the fourth laser beam (221) contacts the charging base (3) at ¾ second; and the fifth laser beam (221) contacts the charging base (3) at 4/4 second. As a matter of fact, the laser module (22) emitting the fifth laser beam (221) is identical to the laser module (22) emitting the first laser beam (221). Each time the laser beams (221) scan and detect the charging base (3), the laser system (2) sends back a signal to the processing system (13), and then the processing system (13) calculates the distance between the robot main body (1) and the charging base (3) and calculates the direction of movement to be corrected by information, e.g. time difference between different laser beams (221) that contacts the charging base (3), directions of the laser beams (221), moving speed of the robot main body (1), and the like. A path (4) is shown in FIG. 3. Accordingly, the processing system (13) can continuously correct the direction of the mobile module (11) by uninterrupted irradiations of the laser beams (221) until the robot main body (1) targets at the charging base (3) to move.

When arriving at the two seats (33) of the charging base (3), the robot main body (1) turns 180 degree, which allows the positive electrode input end (122) and the negative electrode input end (123) of the charging module (12) to correspondingly contact the positive electrode output end (31) and the negative electrode output end (32) of the charging base (3) for charging the storage battery (121), so as to complete a process of mobile robot automatic charging. The invention can be used not only for the cleaning robot but also for other mobile robots that require automatic charging.

According to the above description, in comparison with the traditional technique, a mobile robot having an automatic charging module according to the present invention has the advantages as following:

1. The laser system having the four laser modules arranged at intervals of equal angles can be designed for the four-axis laser system. Furthermore, with an action of the mobile module, the laser system can irradiate the laser beams on a target uninterruptedly so that the robot main body can successfully find the target and know the location of the target.

2. The processing system receiving signals from the laser system and continuously correcting the movement route for the robot main body by information, e.g. time difference between each laser beam that contacts the charging base, directions of the laser beams, moving speed of the robot main body, and the like, can achieve effects of actively finding the location of the charging base and fully automatic charging, which increase convenience in use.

What is claimed is:

1. A mobile robot having an automatic charging module, comprising:
a robot main body having a mobile module, a charging module and a processing system electrically connected to the mobile module and the charging module;
a laser system having a rotation module disposed on a top side of the robot main body and a plurality of laser modules electrically connected to the processing system, wherein the plurality of laser modules are arranged at intervals of equal angles; and
a charging base having a positive electrode output end and a negative electrode output end respectively disposed on two seats thereof.

2. As the mobile robot having an automatic charging module claimed in claim 1, wherein the charging module is provided with a positive electrode input end and a negative electrode input end.

3. As the mobile robot having an automatic charging module claimed in claim 2, wherein the positive electrode input end and the negative electrode input end are electrically connected to a storage battery.

4. As the mobile robot having an automatic charging module claimed in claim 1, wherein each of the plurality of laser modules straight emits a laser beam.

5. As the mobile robot having an automatic charging module claimed in claim 1, wherein the plurality of laser modules are arranged at intervals of 90 degree angles.

6. As the mobile robot having an automatic charging module claimed in claim 1, wherein the rotation module rotates 4-6 turns in one second.

7. As the mobile robot having an automatic charging module claimed in claim 1, wherein each of the two seats is provided with at least one spring.
